(19) United States
(12) Patent Application Publication
(10) Pub. No.: US 2026/0210633 A1
(43) Pub. Date: Jul. 23, 2026

(54) SINTERING FURNACE

(71) Applicant: SECO TOOLS AB, Fagersta (SE)

(72) Inventor: Simone FARINA, Fagersta (SE)

(21) Appl. No.: 19/136,181

(22) PCT Filed: Nov. 20, 2023
(86) PCT No.: PCT/EP2023/082446

§ 371 Date: Jun. 5, 2025

(30) Foreign Application Priority Data
Dec. 7, 2022 (EP) 22211932.3

(51) Int. Cl. F27B 5/16; B22F 3/10; B22F 3/24; C22C 29/06; C22C 29/08; F27D 5/00; F27D 11/00; F27D 17/17

(52) U.S. Cl. CPC F27B 5/16; B22F 3/101; B22F 3/1017; B22F 3/1035; B22F 3/24; C22C 29/067; C22C 29/08; F27D 5/0006; F27D 11/00; F27D 17/17; B22F 2003/248; B22F 2201/013; B22F 2201/02; B22F 2201/11; B22F 2201/20; B22F 2301/15; B22F 2301/205; B22F 2302/10; B22F 2998/10; B22F 2999/00; F27B 2005/162

(57) ABSTRACT

A sintering furnace for sintering of green compacts includes a retort, an inlet for furnace atmosphere gas at one end of the retort, and a stack of sintering trays having central openings arranged in an interior of the retort. Neighboring sintering trays of the stack are spaced apart from one another whereby an interspace is provided between the neighboring sintering trays. The interspace is enclosed by a peripheral wall provided with distributed holes for transfer of the furnace atmosphere gas between the interspace interior of the peripheral wall and the space exterior to the peripheral wall. A ratio of the area of each individual central opening to the total area of the distributed holes between each individual pair of neighboring sintering trays ranges from 1:10 to 10:1. An outlet for withdrawal of the furnace atmosphere gas is located an end of the retort opposite the inlet end.

The present invention relates to a sintering furnace, a method for sintering green compacts in the sintering furnace, and sintered compacts obtainable by the method.

### BACKGROUND OF THE INVENTION

Sintering is a process of treating a solid mass of material, such as a green compact, usually by heat and/or pressure without melting it to the point of liquefaction, to form a sintered product. A sintering furnace is used during the sintering of the powder compacts to increase the product's mechanical strength, density, and translucency.

An essential feature of sintering furnaces is the provision of uniform temperature distribution in the retort of the furnace, especially for sintering of green compacts. Larger temperature gradients may occur during sintering steps where a furnace atmosphere gas is passed through the retort of the furnace. Inhomogeneity of metallurgical parameters such as coercivity, magnetic saturation and shape distortion of the sintered species may occur as a result of inhomogeneous temperature distribution, in particular in small furnaces such as test furnaces but also in moderate-sized and large production furnaces.

The present invention intends to solve the problems addressed above. A further objective of the invention is to provide a compact and energy-efficient sintering furnace with high production capacity.

### THE INVENTION

The present invention relates to a sintering furnace for sintering of green compacts comprising a retort; and
i) an inlet for furnace atmosphere gas at one end of the retort;
ii) a stack of sintering trays comprising central openings arranged in the interior of the retort, said central openings having an area A for transfer of the furnace atmosphere gas introduced through the inlet, wherein neighbouring sintering trays of said stack are spaced apart at a predetermined distance from one another whereby an interspace is provided between said neighbouring sintering trays, said interspace being enclosed by a peripheral wall provided with distributed holes for transfer of the furnace atmosphere gas between the interspace interior of the peripheral wall and the space exterior to the peripheral wall, wherein the ratio of the area A of each individual central opening to the total area of the distributed holes between each individual pair of neighbouring sintering trays ranges from 1:10 to 10:1, preferably 1:5 to 5:1 or 1:3 to 3:1, or 1:3 to 1:10;
iii) an outlet for withdrawal of the furnace atmosphere gas at an end of the retort opposite to the end of the inlet, said inlet and outlet being arranged at opposite ends of the stack of sintering trays.

By the term “retort” is meant a gas-tight chamber in which the green compacts are exposed to a sintering cycle including e.g. vacuum steps and furnace atmosphere gas treatment steps, e.g. nitrogen gas during a process step for nitriding. Preferably, the retort is made of graphite to resist inevitable high temperatures during the sintering cycle.

By the term “furnace atmosphere gas” is meant a gas passed through the retort to treat the green compacts during the sintering cycle.

By the term “opposite ends” is meant ends beyond the volume occupied by the stack of sintering trays extending height H in the retort in an axial direction as further disclosed in FIG. 3. The inlet and the outlet are thus arranged in a volume HE on opposite ends of the stack as well as heat exchangers if such make part of the sintering furnace.

By the term “green compacts” is meant to include unsintered compacts, preferably compacts produced by i) mixing and milling powders forming a binder phase and powders forming hard constituents in a slurry which subsequently are spray dried to a ready-to-press (RTP) powder and ii) pressing the RTP powder into the green compacts. The compacts may subsequently be sintered according to the present invention to eventually form sintered compacts, e.g. sintered cemented carbide or cermet substrates.

By the term “vacuum” as used herein is meant a pressure range below 10⁻¹ mbar during which the vacuum steps of the sintering cycle are performed, preferably between 10⁻⁴ to 10⁻¹ or 10⁻² to 10⁻¹ mbar.

Preferably, the sintering trays, the peripheral wall and any other element exposed to temperatures employed in the retort are made of graphite. The sintering trays are preferably coated with yttria, yttria-zirconia or other metal oxides functioning as a barrier between the green compacts and the graphite material in the sintering trays as commonly known in the art.

The sintering furnace of the invention provides for a homogeneous temperature distribution in the interior of the retort and thereby improved homogeneity of metallurgical parameters such as coercivity, magnetic saturation as well as shape distortion of the sintered species.

According to one embodiment, a heat exchanger for heating the furnace atmosphere gas entering the retort
i) is arranged at the inlet in the interior of the retort such that the furnace atmosphere gas is guided to the heat exchanger; or
ii) constitutes an integral part of the end of the retort (9) at which the inlet is arranged.

According to one embodiment, a heat exchanger for heating the furnace atmosphere gas entering the retort is arranged at an inlet in the interior of the retort.

According to one embodiment, the inlet and outlet constitute integral parts of the heat exchangers. The inlet and outlet may also constitute separate parts. In such embodiments, the inlet and outlet are connected to the respective heat exchanger such that the furnace atmosphere gas can be transferred to and away from the stack of sintering trays. For example, the furnace atmosphere gas entering the retort via the inlet is transferred to the heat exchanger via a channel of the heat exchanger fluidly arranged to the inlet through which channel the furnace atmosphere gas flows while being heated before being transferred to the stack of sintering trays. The heat in the interior of the retort is thus used to heat the introduced furnace atmosphere gas prior to reaching the stack of sintering trays. By use of the heat exchanger at the inlet, the furnace atmosphere gas when reaching the nearest sintering tray obtains a higher temperature than without a heat exchanger.

According to one embodiment, a heat exchanger for recovering heat from the furnace atmosphere gas withdrawn from the retort
i) is arranged at the outlet in the interior of the retort such that the furnace atmosphere gas is guided to the outlet; or
ii) constitutes an integral part of the end of the retort at which the outlet is arranged.

According to one embodiment, the heat exchangers are arranged at the ends of the retort, preferably in a volume of the retort extending axially along a length HE as specified in FIG. 3.

Since the inlet may function as outlet and vice versa during different sintering steps, the transfer of gas may be performed in opposite directions as the inlet/outlet, stack of sintering trays and heat exchangers are fluidly arranged. However, sintering cycles wherein the inlet and outlet always are at the same location are also possible. By the term “fluidly arranged” is meant that the furnace atmosphere gas is conducted to flow i) from the inlet to a heat exchanger if present and then to the stack of sintering trays or ii) from the stack of sintering trays to a heat exchanger if present and then to the outlet. If the inlet and outlet respectively constitute integral parts of the heat exchangers, the heat exchangers are fluidly arranged with the stack of sintering trays in the same way.

According to one embodiment, a heat exchanger is arranged at both the inlet and the outlet of the retort.

By means of the above embodiments comprising at least one heat exchanger, a more homogeneous temperature is enabled in the retort. As the heat exchangers can be designed to smoothly fit the design and volume of the retort, a more homogeneous average temperature of the furnace atmosphere gas has been achieved without significantly reducing the volume of the retort. The heat exchangers may have substantially the same radial extension as the sintering trays or the inner walls of the retort. For example in the case of square-shaped or circular sintering trays or square-shaped or circular retort, the heat exchangers may have corresponding dimensions to utilize the volume as efficiently as possible.

According to one embodiment, a heat exchanger may comprise a channel adapted for essentially radial flow through which furnace atmosphere gas flows prior to reaching the central openings of the sintering trays as further described in FIGS. 4a and 4b. As gas travels through such a channel, the gas is gradually heated resulting in a more homogeneous temperature distribution in the stack of sintering trays. Other designs of heat exchangers may also be used with similar volume or length for gas to travel. The same applies for heat exchangers may function both as inlet and outlet during different steps of the sintering cycle.

Preferably, a heat exchanger is removably arranged on top of the uppermost sintering tray, for example by removable fixing means. With removable attachment of the heat exchanger arranged on top of the uppermost sintering tray, the loading prior to running a sintering cycle and unloading of the sintering trays after running a sintering cycle is facilitated. According to one embodiment, a heat exchanger at the inlet or outlet depending on the flow direction arranged below the lowermost sintering tray of the stack is fixedly or removably arranged to the retort, below the stack of sintering trays.

According to one embodiment, the total length of travel of gas passing through a channel of a heat exchanger at the inlet or outlet of a retort having a volume of 1 dm³ may range from e.g. 150 to 1000, for example from 300 to 600 mm. Corresponding lengths for production furnaces can be dimensioned based on the volume of the retort, flow rates etc to provide accurate heating and recovery of heat.

According to one embodiment, the retort has a volume ranging from 200 to 800 dm³, preferably from 300 to 600 or 400 to 500 dm³.

According to one embodiment, the retort has a volume ranging from 1 to 10 dm³, preferably from 2 to 5 or 2 to 4 dm³.

According to one embodiment, the heat exchanger(s) has a volume ranging from 10 to 100, for example 30 to 80 dm³.

According to one embodiment, the heat exchanger(s) has a volume ranging from 0.1 to 10 dm³, for example 0.5 to 5 dm³ or 0.5 to 2 dm³.

According to one embodiment, the stack of sintering trays comprises 4 to 100, for example 5 to 60, or 4 to 15 or 4 to 10 sintering trays depending on the type of furnace.

According to one embodiment, the stack of sintering trays comprises 60 to 100 sintering trays.

According to one embodiment, the distance h between neighbouring sintering trays ranges from 5 to 200 such as 5 to 100, for example 5 to 15, or 5 to 10 mm. According to one embodiment, the distance h between neighbouring sintering trays ranges from 20 to 100 mm.

According to one embodiment, each individual central opening of the sintering trays has an area A ranging from 100 to 100000 such as from 100 to 10000, or from 1000 to 10000 mm².

According to one embodiment, the height H of the stack of the sintering trays ranges from 100 to 2000, for example 150 to 1000 such as from 400 to 700 mm.

According to one embodiment, the holes in the peripheral wall are substantially uniformly distributed. By substantially uniformly distributed is meant the holes are distributed in such way that radial flow of gas through the peripheral wall is substantially homogenous in order to minimize temperature differences due to flow conditions, for example symmetrically distributed holes or holes distributed at a predetermined distance from one another.

The peripheral wall(s) surrounding the interspace between neighbouring sintering trays is designed such that it encloses the interspace except for the holes in the peripheral wall(s). The peripheral walls may be stacked between neighbouring sintering trays but may also be arranged to the periphery of the sintering trays by other means, preferably by means of removable fixing means. In such an embodiment, for example one single peripheral wall may be used to enclose the interspace of several pairs of neighbouring sintering trays of the stack.

According to one embodiment, the sintering trays and the peripheral wall(s) are alternately stacked without any fixed connection in between.

According to one embodiment, the inlet and outlet are arranged at opposite ends of the retort at positions intersected by an axis extending through all sintering trays.

The area of the holes of the peripheral wall may vary depending on e.g. the size of the sintering trays, the number of holes in the peripheral wall and the diameter of the central openings of the sintering trays, the volume of the retort to provide for a flow pattern such that gas flows axially through the central openings and radially through the holes is optimized to provide for homogeneous temperature distribution. The shape of the holes may be circular but may also take other shapes such as elliptical shape.

According to one embodiment, the sintering trays are circular-shaped, square-shaped or has a rectangular shape, preferably circular-shaped or square-shaped. The peripheral wall is adapted to the shape of the sintering trays to enclose the periphery of the trays.

Preferably, the sintering trays have a diameter or side length ranging from 100 to 2000, for example from 100 to 1000 mm or from 100 to 700 mm or 100 to 300 mm or 100 to 200 mm depending on the type of sintering furnace employed.

According to one embodiment, the sintering furnace comprises a jacket such as a steel jacket surrounding the retort. According to one embodiment, the jacket surrounds at least one heating element arranged exterior to the retort. According to one embodiment, the sintering furnace comprises an insulation package arranged between the jacket and the at least one heating element.

Preferably, when mounting the stack of sintering trays, the sintering trays are aligned by inserting a rod-shaped element with outer dimensions corresponding to the dimensions of the central openings through the central openings of the stacked sintering trays separated by the peripheral walls functioning as spacing elements. The rod-shaped element is subsequently removed from the stack when the aligning is completed.

According to one embodiment, the retort may have any suitable shape such as the shape of a cylinder, cube or a rectangular tank.

According to one embodiment, at least one heating element, such as a single heating element, is arranged externally to the retort. According to one embodiment, two or three heating elements are arranged externally to the retort in a surrounding arrangement. The heating element(s) preferably has a shape corresponding to the retort, for example a cubic or cylindrical shape adapted to be evenly distanced from the retort.

According to one embodiment, no powered heating element such as an electric heating element is arranged in the interior of the walls of the retort. Arrangement of a heat element in the interior of the retort would result in inhomogeneous heating leading to bad eutectic liquid binder development evolution and thus inhomogeneous and unadvantageous results with respect to properties of the sintered species.

According to one embodiment, in the case of a cylindrical heating element and a cylindrical retort, the retort has an outer diameter of 0.3*D_{HT} to 0.99*D_{HT} such as 0.7*D_{HT} to 0.8*D_{HT}, where D_{HT} is the inner diameter of the heating element. The retort may have a wall thickness of for example 5 to 20 mm such as 5 to 10 mm.

According to one embodiment, the furnace is a vertical cylindrical furnace, for example a furnace for experimental use or for minor production.

According to one embodiment, the furnace is a horizontal cylindrical furnace, for example a production furnace.

Preferably, at least one thermocouple is arranged externally to the retort to control the temperature, preferably in the vicinity of the retort wall. The at least one heating element is preferably controlled in a conventional manner, e.g. by means of at least one thermocouple connected to a control unit. According to one embodiment, several thermocouples are arranged externally to the retort to monitor the temperature.

The invention further relates to a method of sintering green compacts in a sintering furnace as disclosed herein comprising performing a sintering cycle involving at least one process step during which a furnace atmosphere gas is supplied to the retort at a pressure ranging from 0.001 to 10 mbars. Certain sintering steps are typically performed at vacuum without flow of furnace atmosphere gas through the retort.

At the end of the sintering cycle, a high pressure gas in the range of 20 to 100 bar may be introduced to avoid undesired defects and enhance densification of the compact.

The flow rate of furnace atmosphere gas in a small furnace <10 dm³ may vary depending on the step of the sintering cycle performed and may range from 0 (if a vacuum step) to 50, for example 0.01 to 50 such as 0.1 to 30 or 0.1 to 25 or 0.1 to 5 or 0.1 to 1 standard L/min whereas production furnaces may have flow rates proportional to their volume. Preferably, a conventional mass flow meter is employed to control the flow rate of furnace atmosphere gas through the retort.

According to one embodiment, the temperature at the sintering trays is monitored by means of ceramic rings with calibrated shrinking behaviour as a function of the temperature and the time, preferably ceramic rings available from e.g. Ferro GmBH (https://www.ferro.com/-/media/files/resources/industrial-specialty-materials/technical/ferro-industrial-specialty-materials-process-temperature-control-rings-ptcr.pdf?la=en&hash=8FD87135E2C3363D07C57D799F8674C6A9405040).

Before initiating any cycle such as a sintering cycle, the ceramic rings are positioned on the sintering trays to retrospectively enable analysis of the temperature distribution. As the shrinkage of the ceramic rings is a function of the heat absorbed, the so called ring temperature RT as referred to herein (which is not a measure in ° C. or K) can be derived from a measurement of the shrinkage of the diameter of the ceramic ring after the sintering cycle has been terminated by means of a micrometer as disclosed by Ferro GmBH. (Microsoft Word—PTCR Manual English Rev. 6_30.07.2019.docx (pxdental.com).

The heat Q referred to in the preceding paragraphs is thus proportional to ΔT, i.e.

$$Q ∼ Δ T * t \qquad ( 1 )$$

wherein ΔT is the firing temperature and t is the firing time. The shrinkage ΔL/L (measurable by micrometer), wherein L corresponds to the original diameter of the ring and ΔL is the change in diameter, is further proportional to the sintering temperature (T) and the sintering time (t), i.e.

$$Δ L / L ∼ {F ( T )}^{⋆} t , \qquad ( 2 )$$

wherein the function F(T) comprises the absolute temperature as well as material specific and geometric factors. The degree of contraction is almost linear over the complete operating range of the ring. Combination of formulas (1) and (2) yields

$$Δ L / L ∼ Q$$

The contraction ΔL/L, i.e. the amount by which the ring diameter has shrunk is thus proportional to the total absorbed quantity of heat Q and can be measured by a micrometer as further described in the Ferro guidelines referred to above.

The invention also relates to a sintered compact obtainable by the process as disclosed herein.

### BRIEF DESCRIPTION OF THE DRAWINGS

FIG. 1 shows a schematic view of a retort arranged in a sintering furnace according to the prior art.

FIG. 2a shows a side view of a retort, a stack of sintering trays and a schematic heat exchanger at the outlet of the retort (FIG. 6b).

FIG. 2b shows a side view of a retort, a stack of sintering trays, and a heat exchanger at the inlet.

FIG. 2c shows a cross section of two sintering trays with an interspace in between.

FIG. 3 shows a side view of a retort and heat exchangers at the inlet and the outlet.

FIGS. 4a and 4b show different embodiments of heat exchangers.

FIG. 5 generally illustrates the steps of a sintering cycle performed in the sintering furnace according to the invention.

FIGS. 6a and 6b show top views of embodiments according to the prior art, wherein a sintering tray is illustrated (FIG. 6a) and a top plate with an opening (inlet/outlet) of the retort.

FIG. 7 shows the resulting ring temperatures of the PTCRs (process temperature control rings) at the sintering trays following a mapping procedure (thermal cycle) performed in the retort according to the prior art and the invention.

FIG. 8 shows the ring temperatures (heat value) after completion of a sintering cycle performed in the retorts according to the prior art and the invention.

FIG. 9 shows the COM values obtained from the same sintering cycle as referred to in FIG. 8.

FIG. 10 shows the resulting He values obtained from the same sintering cycle as referred to in FIG. 8.

FIG. 11 shows a correlation curve of the ring temperatures T (heat value) as a function of the diameters of the PTCRs (process temperature control rings).

### DETAILED DESCRIPTION OF EMBODIMENTS

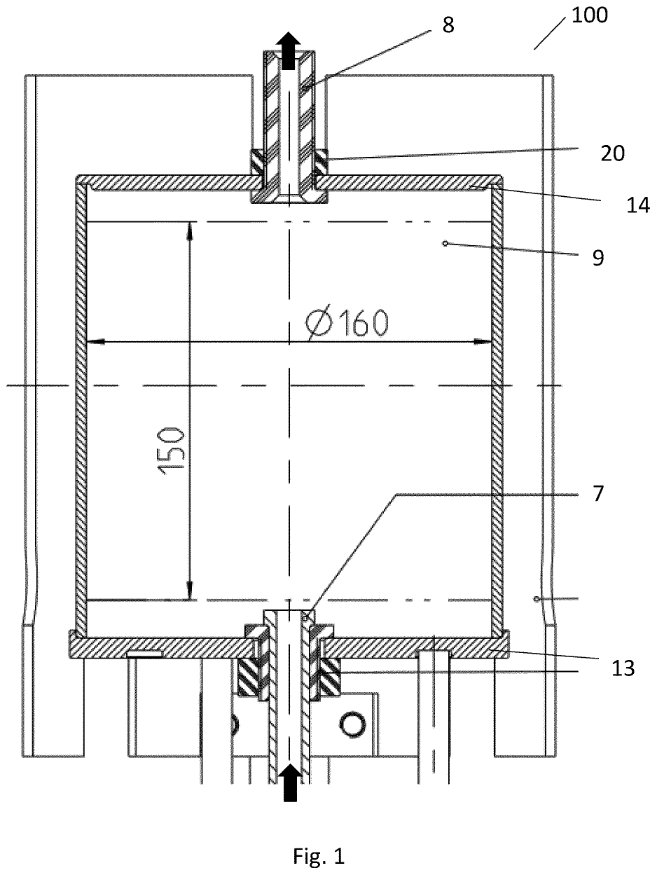

FIG. 1 shows a schematic view of a retort 9 according to the prior art with a bottom plate 13 and a top plate 14 confining the space of the retort 9 in an axial direction. An opening 7 functioning as a gas inlet and an opening 8 functioning as a gas outlet are provided at either end of the retort 9. A graphite element 20 is glued to the top plate 14 and opening 8. The sintering trays arranged in the retort 9 are not shown.

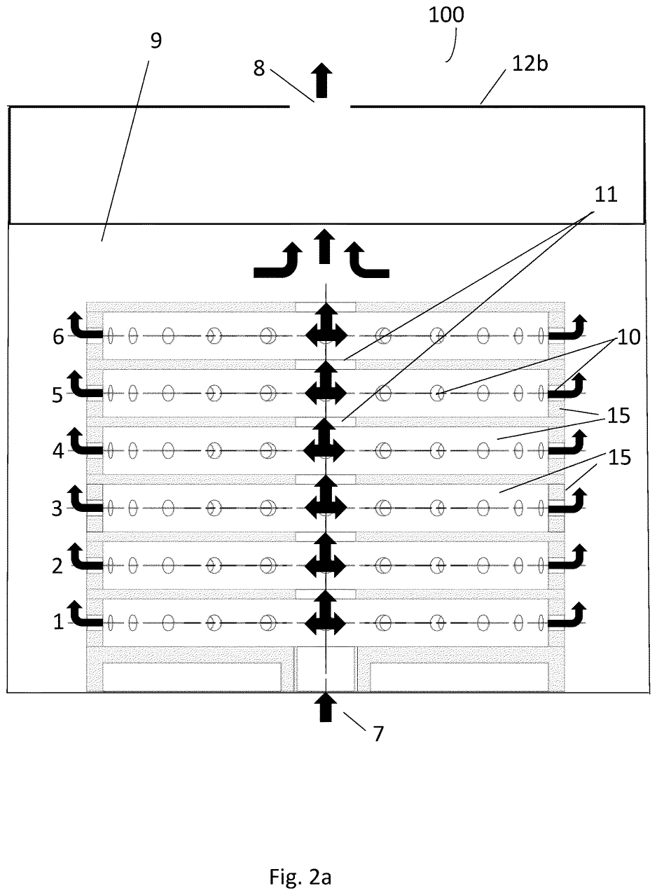

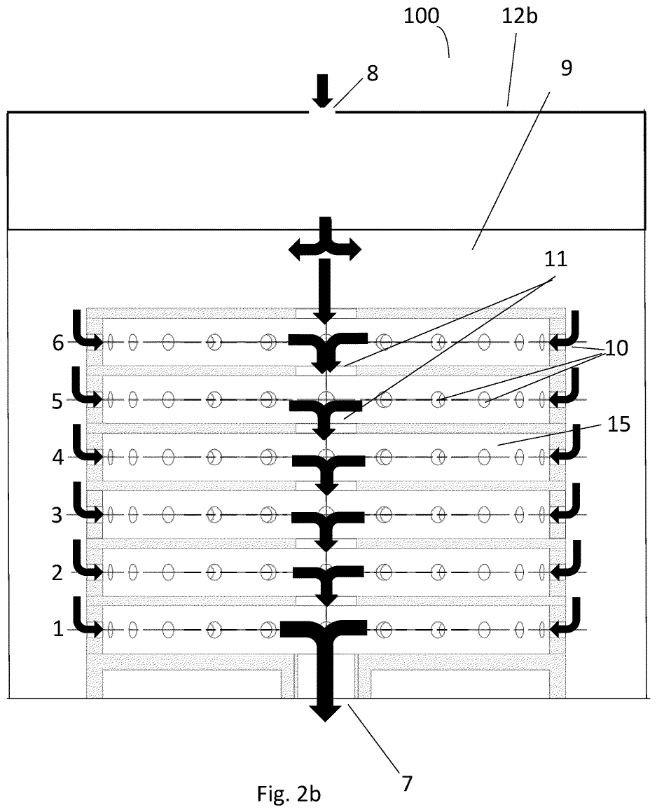

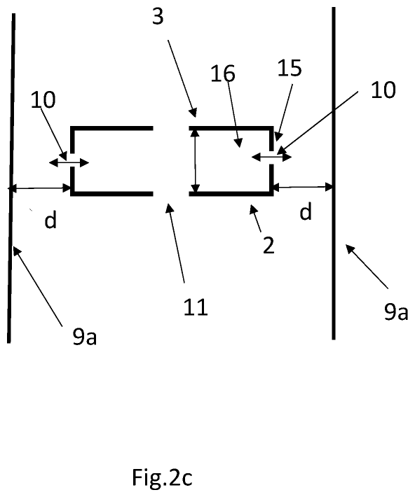

FIG. 2a shows a side view of a stack of sintering trays numbered 1-6 in a retort 9 of a sintering furnace 100 according to the invention. Furnace atmosphere gas enters the retort 9 at inlet 7 and exits the retort 9 at outlet 8 via a schematically illustrated heat exchanger 12b. Inlet 7 and outlet 8 (also collectively called openings in the below) have in the illustrated design a diameter of 14 mm. In an alternative embodiment shown in FIG. 2b, a reversed flow pattern is shown whereby opening 8 functions as an inlet and opening 7 functions as an outlet. Flow patterns as shown in FIGS. 2a and 2b may be employed in different sintering steps during a sintering cycle. The arrows of FIGS. 2a and 2b illustrate the axial flow through the central openings 11 of the sintering trays 1-6. The central openings 11 had a diameter of 19 mm in the conducted trials. The central openings provided for an axial and a radial flow through the interspace 16 between the neighbouring sintering trays 1-6 enclosed by peripheral walls 15 provided with holes 10 which had a diameter of 5 mm. 24 holes between each neighbouring sintering trays were used in the trials. The flow is directed radially outwards to the exterior of the interspace 16 or radially inwards towards the central openings 11 in FIGS. 2a and 2b depending on the sintering step with furnace atmosphere gas. The inlets and outlets of the embodiments of FIGS. 2a and 2b may of course function as both inlets and outlets in some sintering cycles or constantly function as inlet and outlet respectively for other types of sintering cycles.

FIG. 2c shows sintering trays 2 and 3 constituting a neighbouring pair of sintering trays, each of which being provided with central openings 11. A peripheral wall 15 with a height h encloses the interspace 16 between the neighbouring sintering trays 2 and 3. The peripheral wall 15 arranged between the neighbouring trays also has the function of a spacing element in this embodiment. The shape of a peripheral wall 15 enclosing the circular sintering trays had a cylindrical shape. Additional peripheral walls 15 (not shown) enclose the further neighbouring pairs of sintering trays (not shown). In an alternative embodiment, one single peripheral wall 15 covers all pairs of neighbouring sintering trays (not shown). In such an embodiment, additional spacing elements may be needed to maintain the sintering trays at a predetermined distance. Holes 10 are provided in the peripheral wall 15 (only two holes are shown in FIG. 2c). Depending on the flow pattern, furnace atmosphere gas may flow radially outwards or inwards through the holes 10 as illustrated by the arrows in FIG. 2c. The distance d between the wall 9a of the retort 9 and the peripheral wall 15 enables flow in the space between the peripheral wall 15 and the retort towards the outlet.

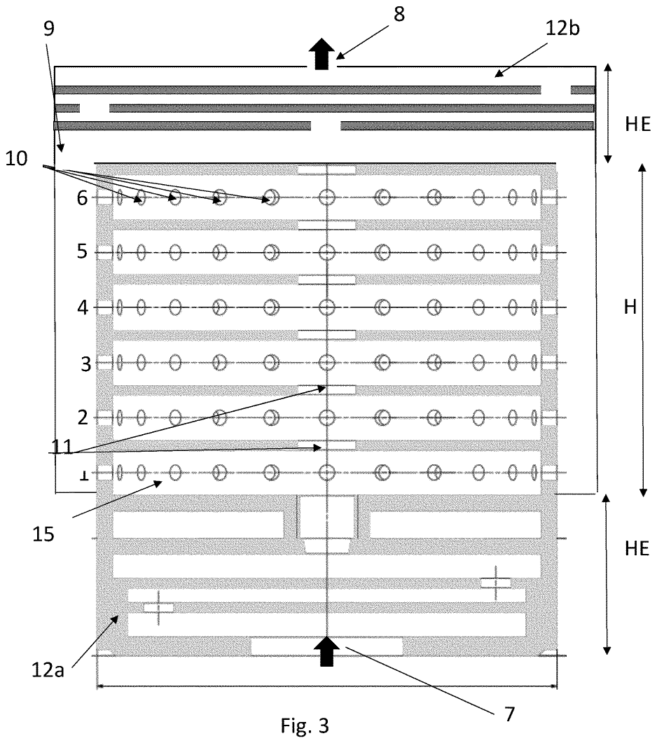

FIG. 3 shows a bottom heat exchanger 12a and a top heat exchanger 12b arranged to allow passage of furnace atmosphere gas to and away from the stack of sintering trays 1-6 arranged in between the heat exchangers 12a and 12b. The heat exchanger 12a allows for pre-heating of the furnace atmosphere gas entering inlet 7 such that the temperature of the furnace atmosphere gas is raised from room temperature before reaching the inlet of the retort to a temperature of up to about 500 to 700° C. depending on the flow rate of the furnace atmosphere gas and the temperature in the retort. The top heat exchanger 12b provides for recovery of heat remaining in the gas exiting the retort 9. If furnace atmosphere gas instead enters at the opening 8 functioning as an inlet (not shown in FIG. 3) arranged at the top of the heat exchanger 12b and exits via the opening 7 (functioning as an outlet) at the bottom heat exchanger 12a, the temperature in the retort 9 will in the same way be homogenized by pre-heating the entering gas by means of heat exchanger 12b and recovering heat from the exiting gas by means of heat exchanger 12a.

Green compacts (not shown) were positioned prior to starting the sintering cycle in a conventional manner on sintering trays 1-6. The interspaces 16 between the neighbouring sintering trays were enclosed by peripheral walls 15 provided with uniformly distributed holes 10 through which furnace atmosphere gas present inside the peripheral wall 15 could pass through the enclosed interspace 16. The height of the stack of the sintering trays was H=122 mm in the illustrated design of FIG. 3. The central openings 11 provided in the sintering trays 1-6 allowed entering gas to flow axially from inlet 7 towards outlet 8 arranged on top of the stack of the sintering trays. The opposite flow direction may also apply in FIG. 3 as shown in e.g. FIG. 2b. Both flow directions may thus apply during different steps while performing a sintering cycle.

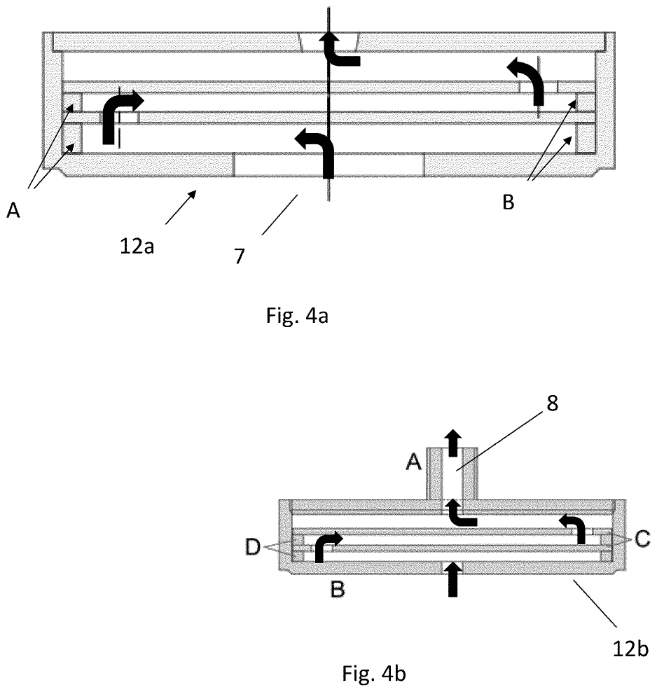

FIGS. 4a and 4b exemplify the flow pattern of the furnace atmosphere gas through the respective bottom heat exchanger 12a in FIG. 4a and top heat exchanger 12b in FIG. 4b as indicated by the arrows.

In FIG. 4a, opening 7 is an inlet and opening 8 is an outlet. The opposite flow direction will apply if the furnace atmosphere gas enters via opening 8 (inlet) during another sintering step and exits via opening 7 (outlet). Letters A, B, C and D refer to elements of the channel design of the heat exchangers 12a and 12b. The heat exchanger 12a as used in all embodiments of the working examples had a width (radial extension) of 150 mm and a height of 38 mm. The inlet had a diameter of 14 mm. The heat exchanger 12a was made up of a channel adapted for radial gas flow with a total heat exchange volume of 0.672 dm³. The heat exchanger 12b had a width of 165 mm and a height of 36 mm. The heat exchanger 12b having a volume of 0.77 dm³ was likewise made up of a channel for flow of gas.

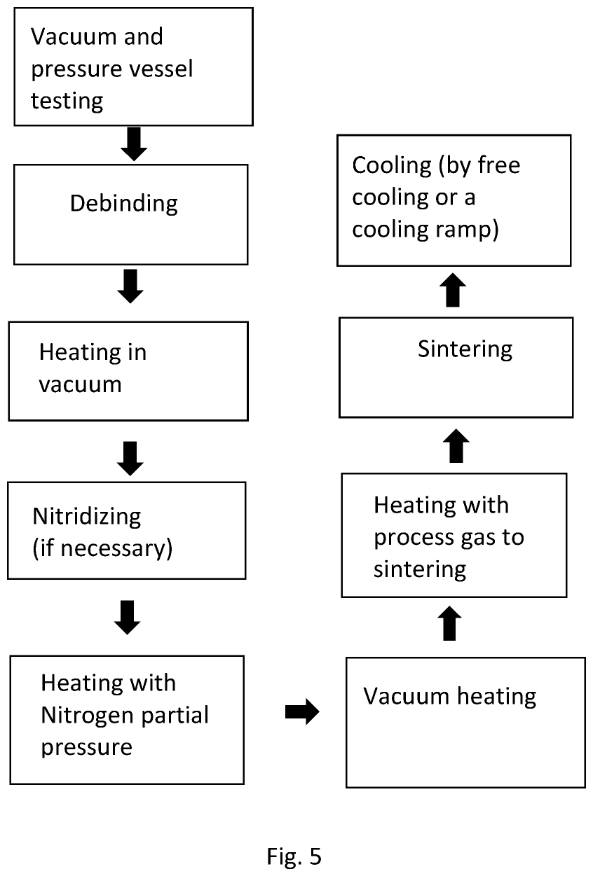

FIG. 5 generally illustrates a typical sintering cycle performed in the sintering furnace 100 according to the invention comprising the following steps:
1. Vacuum and pressure vessel testing
2. Filling of the retort with argon
3. Debinding pressure regulation controlled by the burning tower
4. Exchange from filling of the retort with argon to flushing of the retort with hydrogen
5. Debinding by filling the retort from the top heat exchanger that preheats the entering gas before passing the furnace atmosphere gas to the stack of sintering trays
6. Vacuum heating
7. N₂ filling to a debinding pressure (overpressure) for performing a nitridizing step. Nitrogen gas enters the retort from the top heat exchanger to homogenise the temperature whereby the gas is heated up before passing it to the stack of sintering trays for solid state reactions
8. N₂ gas (at reduced pressure-partial pressure) enters the retort via the bottom heat exchanger and flows through the stack of the sintering trays from tray 1 to tray 6. The gas thus flows in the opposite direction compared to step 7. The bottom heat exchanger homogenises the temperature before the nitrogen gas reaches the stack of sintering trays
9. Vacuum heating
10. Heating with furnace atmosphere gas to the sintering temperature
11. Sintering
12. Cooling (by free cooling or a cooling ramp)

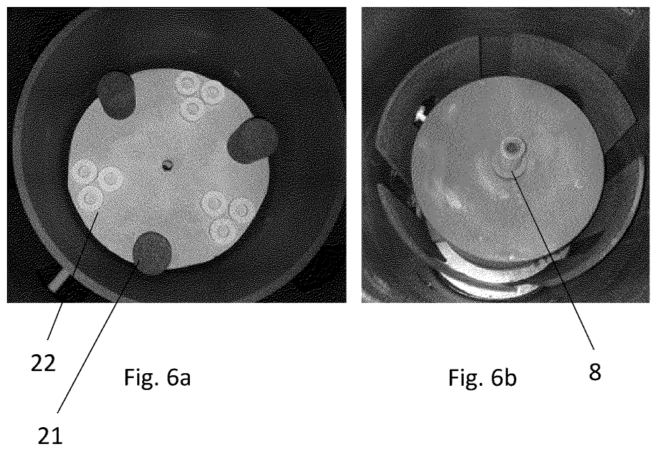

FIG. 6a is an embodiment of the prior art showing a sintering tray on which conventional spacer elements 21 are piled on sintering trays to provide an interspace 16 between neighbouring sintering trays. PTCRs (process temperature control rings) 22 are likewise positioned on the sintering trays. FIG. 6b shows a top plate with opening 8 functioning as inlet/outlet of gas.

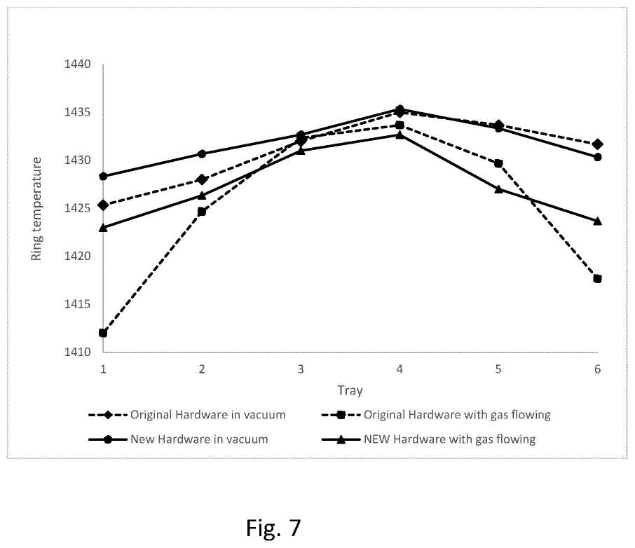

FIG. 7 shows the ring temperatures for the respective sintering trays measured after completion of the mapping performed by running a thermal cycle i) at vacuum and ii) while passing a furnace atmosphere gas at reduced pressure respectively.

In FIGS. 7-10, the term “Original Hardware” signifies the design according to FIG. 1 and FIGS. 6a and 6b (reference) and the term “New Hardware” signifies the design according to FIG. 3 (the invention).

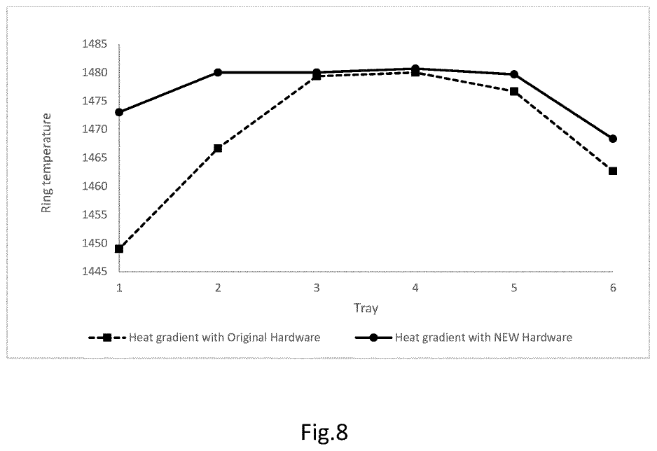

FIG. 8 shows the ring temperatures measured following completion of the entire sintering cycle (25 step cycle).

### EXAMPLES

A sintering cycle according to table 1 was run in a sintering furnace, COV 131 R, commercially available from PVA TePla, to produce a functional graded material (cemented carbide) from the starting RTP (ready-to-press) powder with a nominal composition of 5.3 wt % Co and 2.2 wt % Ta/Nb/Ti in a weight ratio 3.4/2.0/2.1 as binder content and the remainder as WC. The sintering trays in all examples had a diameter of 150 mm.

The designs of the retort 9 and arrangement of the sintering trays in the furnace tested were as illustrated in FIGS. 1 and 6a and 6b (reference) and FIG. 3 (invention).

In the design of the reference, 6 sintering trays were piled up in the retort 9 which sintering trays were spaced apart by distance elements as shown in FIG. 6a. A bottom plate 13 and a top plate 14 as shown in FIG. 6b confined the retort in an axial direction. As evident from FIG. 3, the same number of sintering trays were arranged in the embodiment according to the invention in combination with heat exchangers 12a and 12b arranged at the inlet and the outlet. Instead of the spacer elements of the reference, peripheral rings 15 provided with holes 10 were stacked between the sintering trays functioning as both enclosing wall and spacer elements.

A thermocouple was arranged externally to the retort 9 in the vicinity of sintering trays 3 and 4 for both the reference and the invention embodiments.

### Functionality Test

A functionality test composed of two tests was performed in the furnace before running the sintering cycle of table 1:
i) a leak rate test; and
ii) an overpressure test

During the leak rate test i), the pressure in the furnace was pumped down to 10⁻² to 10⁻³ mbars for 30 min. Then, the pumping unit for furnace atmosphere gases was turned off and all valves for controlling gas flow in the furnace were closed to monitor the pressure increase over time. A leak rate of 2.3*10⁻⁴ mbar*L/s was estimated.

The overpressure test ii) was performed by filling up the system with argon to 1200 mbars, whereafter all valves were closed. The pressure decrease was monitored to be below 5 mbars/h.

TABLE 1
Sintering cycle

| STEP | 1 | 2 | 3 | 4 | 5 | 6 | 7 | 8 | 9 | 10 | 11 | 12 | 13 | 14 |
|---|---|---|---|---|---|---|---|---|---|---|---|---|---|---|
| Process step | 1 | 3 | 3 | 3 | 3 | 3 | 3 | 1 | 1 | 1 | 1 | 4 | 1 | 1 |
| Duration | 0 | 1 | 4 | 10 | 10 | 40 | 20 | 5 | 17 | 5 | 1 | 50 | 1 | 5 |
| (min) | | | | | | | | | | | | | | |
| Temperature | 30 | 30 | 100 | 290 | 340 | 370 | 450 | 700 | 1240 | 1250 | 1250 | 1250 | 1250 | 1350 |
| (° C.) | | | | | | | | | | | | | | |
| Time (min) | 0 | 1 | 5 | 15 | 25 | 65 | 85 | 90 | 107 | 112 | 113 | 163 | 164 | 169 |
| T tolerance | 10 | 20 | 10 | 5 | 5 | 5 | 5 | 10 | 10 | 5 | 5 | 5 | 5 | 7 |
| (° C.) | | | | | | | | | | | | | | |
| Pressure | 0 | 1020 | 1020 | 1020 | 1020 | 1020 | 1020 | 0 | 0 | 0 | 0 | 1020 | 60 | 60 |
| (mbars) | | | | | | | | | | | | | | |
| H2 Flow | 0 | 20 | 5 | 5 | 5 | 5 | 5 | 0 | 0 | 0 | 0 | 0 | 0 | 0 |
| (L/min) | 0 | 0 | 0 | 0 | 0 | 0 | 0 | 0 | 0 | 0 | 0 | 0 | 0 | 0 |
| N2 flow | 0 | 0 | 0 | 0 | 0 | 0 | 0 | 0 | 0 | 0 | 0 | 1 | 1 | 1 |
| (L/min) | | | | | | | | | | | | | | |
| Ar flow | 0 | 0 | 0 | 0 | 0 | 0 | 0 | 0 | 0 | 0 | 0 | 0 | 0 | 0 |
| (L/min) | | | | | | | | | | | | | | |
| CO flow | 0 | 0 | 0 | 0 | 0 | 0 | 0 | 0 | 0 | 0 | 0 | 0 | 0 | 0 |
| (L/min) | | | | | | | | | | | | | | |

| STEP | 15 | 16 | 17 | 18 | 19 | 20 | 21 | 22 | 23 | 24 | 25 |
|---|---|---|---|---|---|---|---|---|---|---|---|
| Process step | 6 | 6 | 1 | 1 | 6 | 6 | 6 | 1 | 7 | 7 | 7 |
| Duration | 1 | 30 | 1 | 3 | 1 | 24 | 40 | 1 | 40 | 180 | 120 |
| (min) | | | | | | | | | | | |
| Temperature | 1350 | 1350 | 1350 | 1380 | 1380 | 1495 | 1495 | 1495 | 1100 | 600 | 50 |
| (° C.) | | | | | | | | | | | |
| Time (min) | 170 | 200 | 201 | 204 | 205 | 229 | 269 | 270 | 310 | 490 | 610 |
| T tolerance | 5 | 5 | 5 | 5 | 5 | 5 | 5 | 5 | 20 | 20 | 20 |
| (° C.) | | | | | | | | | | | |
| Pressure | 60 | 60 | 0 | 0 | 40 | 40 | 40 | 0 | 600 | 600 | 600 |
| (mbars) | | | | | | | | | | | |
| H2 Flow | 0 | 0 | 0 | 0 | 0 | 0 | 0 | 0 | 0 | 0 | 0 |
| (L/min) | 0 | 0 | 0 | 0 | 0 | 0 | 0 | 0 | 0 | 0 | 0 |
| N2 flow | 1 | 1 | 0 | 0 | 0 | 0 | 0 | 0 | 0 | 0 | 0 |
| (L/min) | | | | | | | | | | | |
| Ar flow | 0 | 0 | 0 | 0 | 0.5 | 0.5 | 0.5 | 0 | 0 | 0 | 0 |
| (L/min) | | | | | | | | | | | |
| CO flow | 0 | 0 | 0 | 0 | 0.5 | 0.5 | 0.5 | 0 | 0.5 | 0.5 | 0.5 |
| (L/min) | | | | | | | | | | | |

The steps of the sintering cycle of table 1 are further described in the below:

### Steps 1 to 2:

The retort was first filled up with argon which preceded step 1 of the sintering cycle. After the set point at 1020 mbars had been reached, the argon filling was exchanged for hydrogen.

### Steps 3 to 7:

The green compacts positioned on the sintering trays in the retort were debound.

### Steps 8 to 11:

The debound green compacts were heated in vacuum.

### Steps 12:

The green compacts were subjected to solid state nitridizing to increase the nitrogen content of the cemented carbide green compacts.

### Steps 13 to 16:

Nitrogen back pressure was applied to avoid nitrogen losses before reaching the liquid phase sintering.

### Steps 17 to 18:

Heating steps during which the green compacts started to reach the liquid phase sintering temperature at which further shrinking took place were performed.

### Steps 19 to 21:

A sintering atmosphere (Ar/CO) was added to avoid cobalt evaporation from the cemented carbides.

### Steps 22 to 25:

The cooling steps 22-25 involved free cooling.

### Example 1

Before starting the sintering cycle according to table 1, the temperature in the retort of the reference was mapped. Shrinking PTCR rings commercially available from Ferro GmbH, batch number 332, were positioned on the 6 sintering trays, three rings on each sintering tray uniformly distributed (120° apart in a way similar to the prior art embodiment illustrated in FIG. 6a but only with 3 rings per tray).

The mapping was performed in accordance with the standardized method of the PCTR supplier Ferro GmbH according to the following thermal cycle:
i) vacuum treatment at 10⁻¹ to 10⁻² mbars with ramped heating from room temperature to the sintering temperature at 1470° C. at a rate of 3° C./min
ii) soaking (holding time) for 90 minutes at the same pressure
iii) free cooling from 1470° C. in vacuum to 1200° C. at the same pressure
iv) free cooling at 600 mbars with argon gas until room temperature was reached

A reference point (zero point) was obtained from the mapping with the PTCRs in the retort design of the reference.

The result of example 1 (reference) is presented in table 2 and FIG. 7.

Table 2 shows the individual ring temperatures of the PTCR rings positioned on trays 1-6 at the three positions (120° apart from one another), and the averaged ring temperatures. The average ring temperature calculated from the averaged ring temperatures of tray numbers 1-6 was 1431 which differed 4 degrees from the target temperature (desired temperature) 1435. An offset of 4 degrees from the target was thus registered which still was within the limits of the specifications from the supplier (±7K). A gradient of ΔT=11 was registered corresponding to the maximum difference between highest and lowest ring temperature during the trial (1425 and 1436 respectively as evident from table 2).

TABLE 2

| Tray | | | | T |
|---|---|---|---|---|
| number | T1*0°* | T2 120° | T3 240° | Average |
| 6 | 1431 | 1432 | 1432 | 1432 |
| 5 | 1433 | 1433 | 1435 | 1434 |
| 4 | 1435 | 1434 | 1436 | 1435 |
| 3 | 1431 | 1432 | 1433 | 1432 |
| 2 | 1428 | 1429 | 1427 | 1428 |
| 1 | 1425 | 1425 | 1426 | 1425 |

T* signifies the ring temperature of the ring (the rings being T1, T2, T3)
0°* signifies the position of T1 relative to the other rings (to detect
variations around the tray)

| T | T | | |
|---|---|---|---|
| average | Target | ΔT | Offset |
| 1431 | 1435 | 11 | −4 |

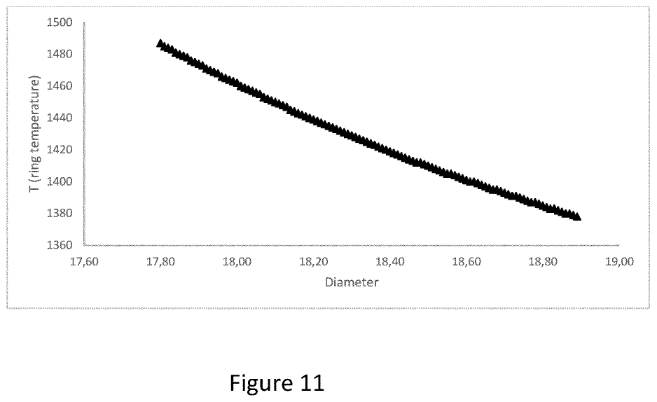

The ring temperatures (RT) were retrieved from measurements of the diameter of the PTCRs (process temperature control rings) at room temperature with a micrometer after having terminated the sintering cycle according to guidelines of the supplier Ferro GmbH https://www.ferro.com/-/media/files/resources/industrial-specialty-materials/technical/ferro-industrial-specialty-materials-process-temperature-control-rings-ptcr.pdf?la=en&hash=8FD87135E2C3363D07C57D799F8674C6A9405040, (Microsoft Word PTCR Manual English Rev. 6_30.07.2019.docx (pxdental.com)). The ring temperatures were retrieved by correlating the measured diameters with the ring temperatures (RT) as illustrated by the ring temperature (RT)-diameter curve in FIG. 11.

### Example 2

The thermal cycle performed in example 1 was repeated using the retort design of FIG. 3 (the invention). The result of example 2 is shown in table 3 and FIG. 7. In FIG. 7, a significant difference in temperature distribution can be noted between examples 1 (reference) and 2 (invention) even though both of them were performed under vacuum treatment. The results thus show that the design according to the invention also without passing furnace atmosphere gas through the heat exchangers (see FIG. 3) results in a more homogeneous temperature distribution.

TABLE 3

| Trays | | | | Average |
|---|---|---|---|---|
| Number | T1 0° | T2 120° | T3 240° | T |
| 6 | 1430 | 1431 | 1430 | 1430 |
| 5 | 1433 | 1433 | 1434 | 1433 |
| 4 | 1436 | 1435 | 1435 | 1435 |
| 3 | 1433 | 1432 | 1433 | 1433 |
| 2 | 1430 | 1431 | 1431 | 1431 |
| 1 | 1428 | 1429 | 1428 | 1428 |

| T | T | | |
|---|---|---|---|
| average | Target | ΔT | Offset |
| 1432 | 1435 | 8 | −3 |

### Example 3

The thermal cycle of example 3 was performed as in example 1 (in the reference design) with the exception that 1 standard L/min inert gas (typically Ar, possibly CO) was flowing through the retort at a pressure of 40 mbars during the soaking step ii) which resulted in a decrease in temperature homogeneity, especially at sintering tray 1 in the vicinity of the gas inlet. The result of example 3 is shown in table 4 and in FIG. 7.

TABLE 4

| Tray | Diam- | | Diam- | | Diam- | | Aver- |
|---|---|---|---|---|---|---|---|
| number | eter | T1 0° | eter | T2 120° | eter | T3 240° | age T |
| 6 | 18.411 | 1418 | 18.414 | 1418 | 18.424 | 1417 | 1418 |
| 5 | 18.280 | 1431 | 18.289 | 1430 | 18.308 | 1428 | 1430 |
| 4 | 18.239 | 1435 | 18.255 | 1433 | 18.259 | 1433 | 1434 |
| 3 | 18.263 | 1433 | 18.268 | 1432 | 18.265 | 1432 | 1432 |
| 2 | 18.348 | 1424 | 18.343 | 1425 | 18.338 | 1425 | 1425 |
| 1 | 18.467 | 1412 | 18.473 | 1412 | 18.469 | 1412 | 1412 |

| T average | T Target | ΔT | Offset |
|---|---|---|---|
| 1425 | 1435 | 23 | −10 |

### Example 4

The thermal cycle of example 4 was performed in accordance with example 3 using the design of FIG. 3 (the invention). The result is presented in table 5 and FIG. 7. As can be seen in FIG. 7, a significantly smaller temperature difference can be noted for example 4 according to the invention, especially at tray 1 in the vicinity of the gas inlet and heat exchanger during the step performed at reduced pressure (partial pressure) compared to example 3 (reference). The result thus shows that the heat exchanger contributes to a more homogeneous temperature distribution (in particular at trays 1 and 2).

TABLE 5

| Trays | Diam- | | Diam- | | Diam- | | Aver- |
|---|---|---|---|---|---|---|---|
| Number | eter | T 0° | eter | T 120° | eter | T3 240° | age T |
| 6 | 18.394 | 1420 | 18.352 | 1424 | 18.321 | 1427 | 1424 |
| 5 | 18.310 | 1428 | 18.322 | 1427 | 18.325 | 1426 | 1427 |
| 4 | 18.265 | 1432 | 18.262 | 1433 | 18.258 | 1433 | 1433 |
| 3 | 18.266 | 1432 | 18.284 | 1431 | 18.289 | 1430 | 1431 |
| 2 | 18.342 | 1425 | 18.315 | 1427 | 18.321 | 1427 | 1426 |
| 1 | 18.382 | 1421 | 18.374 | 1422 | 18.325 | 1426 | 1423 |

| T average | T Target | ΔT | Offset |
|---|---|---|---|
| 1427 | 1435 | 13 | −8 |

### Example 5

The sintering cycle according to table 1 was run with the reference retort design (FIG. 1) and the invention design (FIG. 3). It could be shown the design of the invention outperformed the reference design when running the sintering cycle. The results using the reference design and the invention design are shown in table 6a (reference), table 6b (invention) and FIG. 8. It can be noted the invention design outperforms the reference with respect to its homogeneous temperature distribution.

TABLE 6a
(reference)

| Trays | Diam- | | Diam- | | Diam- | | Aver- |
|---|---|---|---|---|---|---|---|
| Number | eter | T 0° | eter | T 120° | eter | T 240° | age T |
| 6 | 17.990 | 1463 | 18.000 | 1462 | 17.990 | 1463 | 1463 |
| 5 | 17.880 | 1476 | 17.870 | 1478 | 17.880 | 1476 | 1477 |
| 4 | 17.840 | 1481 | 17.860 | 1479 | 17.850 | 1480 | 1480 |
| 3 | 17.840 | 1481 | 17.860 | 1479 | 17.870 | 1478 | 1479 |
| 2 | 17.940 | 1469 | 17.970 | 1465 | 17.960 | 1466 | 1467 |
| 1 | 18.100 | 1450 | 18.110 | 1449 | 18.120 | 1448 | 1449 |

TABLE 6b
(invention)

| Trays | Diam- | | Diam- | | Diam- | | Aver- |
|---|---|---|---|---|---|---|---|
| Number | eter | T 0° | eter | T 120° | eter | T 240° | age T |
| 6 | 17.920 | 1471 | 17.970 | 1465 | 17.940 | 1469 | 1468 |
| 5 | 17.820 | 1484 | 17.850 | 1480 | 17.890 | 1475 | 1480 |
| 4 | 17.830 | 1483 | 17.860 | 1479 | 17.850 | 1480 | 1481 |
| 3 | 17.850 | 1480 | 17.860 | 1479 | 17.840 | 1481 | 1480 |
| 2 | 17.850 | 1480 | 17.860 | 1479 | 17.840 | 1481 | 1480 |
| 1 | 17.900 | 1474 | 17.940 | 1469 | 17.880 | 1476 | 1473 |

| Reference (table 6a) | | | | | Invention (table 6b) | | | |
|---|---|---|---|---|---|---|---|---|
| T | T | | | | T | T | | |
| average | Target | ΔT | Offset | | average | Target | ΔT | Offset |
| 1469 | 1470 | 33 | −1 | [symbol] | 1477 | 1470 | 19 | 7 |

By sintering the green compacts (cemented carbide), more homogeneous metallurgical properties in terms of magnetic properties such as Coercivity force (He) and Magnetic Saturation (Com) were noted for the design of the invention than for the design of the reference.

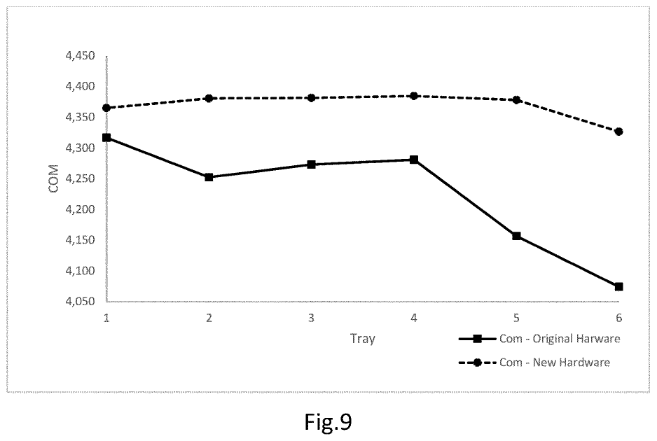

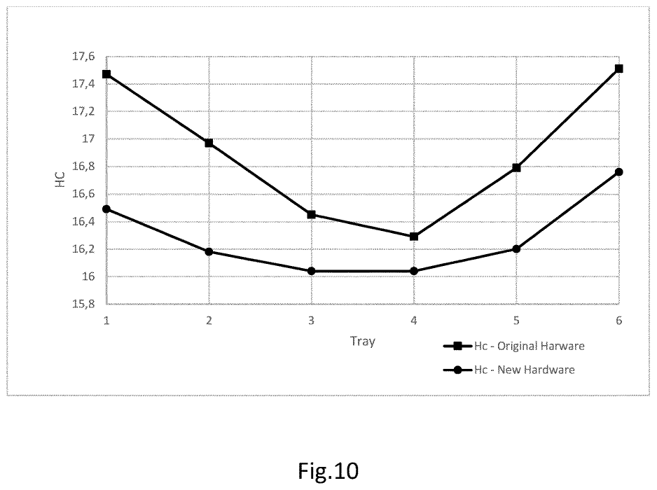

Table 7a shows the result with respect to H_{c} and Com for the reference and table 7b shows the corresponding result of the invention. It can be concluded the homogeneity of the metallurgical properties is improved over the entire sintering cycle (including nitridizing step) for the design according to the invention compared to the reference as further shown in FIGS. 9 and 10 compared to the reference.

TABLE 7a
(reference)

| Trays | | | |
|---|---|---|---|
| Number | MM | H_{c} | Com |
| 6 | 13.48 | 17.51 | 4.074 |
| 5 | 12.47 | 16.79 | 4.157 |
| 4 | 10.95 | 16.29 | 4.281 |
| 3 | 11.05 | 16.45 | 4.273 |
| 2 | 11.30 | 16.97 | 4.252 |
| 1 | 10.51 | 17.47 | 4.317 |

| ΔHc | ΔCom |
|---|---|
| 1.22 | 0.243 |

TABLE 7b
(invention)

| Tray | | | |
|---|---|---|---|
| numbers | MM | H_{c} | Com |
| 6 | 10.39 | 16.76 | 4.327 |
| 5 | 9.76 | 16.2 | 4.378 |
| 4 | 9.68 | 16.04 | 4.385 |
| 3 | 9.72 | 16.04 | 4.381 |
| 2 | 9.73 | 16.18 | 4.380 |
| 1 | 9.92 | 16.49 | 4.365 |

| ΔHc | ΔCom |
|---|---|
| 0.72 | 0.058 |

1. A sintering furnace for sintering of green compacts comprising:
a retort;
an inlet for furnace atmosphere gas at one end of the retort;
a stack of sintering trays including central openings arranged in an interior of the retort, said central openings having an area for transfer of the furnace atmosphere gas introduced through the inlet, wherein neighbouring sintering trays of said stack are spaced apart at a predetermined distance from one another whereby an interspace is provided between said neighbouring sintering trays, said interspace being enclosed by a peripheral wall provided with distributed holes for transfer of the furnace atmosphere gas between the interspace interior of the peripheral wall and a space exterior to the peripheral wall, wherein a ratio of the area of each individual central opening to a total area of the distributed holes between each individual pair of neighbouring sintering trays ranges from 1:10 to 10:1; and
an outlet for withdrawal of the furnace atmosphere gas at an end of the retort opposite to an end of the inlet, said inlet and outlet being arranged at opposite ends of the stack of sintering trays.

2. The sintering furnace according to claim 1, wherein a heat exchanger for heating the furnace atmosphere gas entering the retort:
is arranged at the inlet in the interior of the retort such that the furnace atmosphere gas is guided to the heat exchanger; or
constitutes an integral part of the end of the retort at which the inlet is arranged.

3. The sintering furnace according to claim 1, wherein a heat exchanger arranged for recovering heat from the furnace atmosphere gas withdrawn from the retort;
is arranged at the outlet in the interior of the retort such that the furnace atmosphere gas is guided to the outlet; or
constitutes an integral part of the end of the retort at which the outlet is arranged.

4. The sintering furnace according to claim 2, wherein a heat exchanger is arranged at both the inlet and the outlet of the retort.

5. The sintering furnace according to claim 1, wherein the stack of sintering trays includes 4 to 100 sintering trays.

6. The sintering furnace according to claim 1, wherein a distance between neighbouring sintering trays ranges from 5 to 200 mm.

7. The sintering furnace according to claim 1, wherein each individual central opening of the sintering trays has an area ranging from 100 to 100000 mm².

8. The sintering furnace according to claim 1, wherein at least one heating element is arranged exterior to the retort.

9. The sintering furnace according to claim 1, wherein no powered heating element is arranged in the interior of the retort.

10. The sintering furnace according to claim 1, wherein the distributed holes are substantially uniformly distributed.

11. The sintering furnace according to claim 1, wherein the inlet and outlet are arranged at opposite ends of the retort at positions intersected by an axis extending through all the sintering trays.

12. The sintering furnace according to claim 1, wherein heat exchangers are arranged in the interior of the retort, wherein the inlet and outlet constitute integral parts of the heat exchangers.

13. A method of sintering green compacts in a sintering furnace according to claim 1, comprising:
performing a sintering cycle involving at least one process step during which a furnace atmosphere gas is supplied to an inlet of the retort at a pressure ranging from 0.001 to 10 mbars.

14. A sintered compact obtainable by the method according to claim 13.
